(19) United States
(12) Patent Application Publication
(10) Pub. No.: US 2020/0368585 A1
(43) Pub. Date: Nov. 26, 2020

(54) BOWLING BALLS AND METHODS OF FORMING THE SAME

(71) Applicant: Brunswick Bowling Products, LLC, Muskegon, MI (US)

(72) Inventors: Raymond M. Edwards, Grand Rapids, MI (US); William Orlikowski, Grand Rapids, MI (US)

(21) Appl. No.: 16/897,934

(22) Filed: Jun. 10, 2020

Related U.S. Application Data
(63) Continuation of application No. 15/944,131, filed on Apr. 3, 2018.

(51) Int. Cl. A63B 37/00; A63B 37/10; A63B 45/00; A63B 37/04

(52) U.S. Cl. CPC A63B 37/0001; A63B 37/10; B29C 37/0025; A63B 37/04; A63B 45/00

(57) ABSTRACT

A bowling ball can have an inner core layer that is shaped, constructed, and/or configured to provide the bowling ball with one or more prescribed properties or characteristics, and a cover stock layer comprising a liquid curable material received about the inner core layer. The bowling ball further has a riser pin feature that is at least partially defined by a passage extending through at least the cover stock layer and in which a filler material is received. The riser pin feature can be located in an opposite hemisphere of the bowling ball from a hemisphere including the true center of gravity and a marked heavy spot of the bowling ball and can be arranged within about 1 inch of an end of the Low Radius of Gyration Axis of the bowling ball.

### CROSS-REFERENCE TO RELATED APPLICATIONS

The present Patent Application is a continuation of previously filed, co-pending U.S. patent application Ser. No. 15/944,131, filed on Apr. 3, 2018.

### INCORPORATION BY REFERENCE

The specification and drawings of U.S. patent application Ser. No. 15/944,131 filed Apr. 3, 2018 are specifically incorporated herein by reference as if set forth in their entireties.

### TECHNICAL FIELD

The present disclosure is directed to bowling, and more specifically to bowling balls.

### DISCUSSION OF RELATED ART

As bowling has increased in popularity, ball customization, such as for achieving more user specific gripping patterns, performance characteristic, aesthetics, etc., has likewise increased. Bowling balls, however, do still need to meet industry standard specifications, and/or regulations, such as those promulgated by the United States Bowling Congress (“USBC”), which can thus limit the extent of such customization. For example, USBC regulations require one end of the low radius of gyration (RG) axis of the ball for high performance bowling balls be within a 1″ radius of the center of the riser pin used for supporting the core within the sphere of the ball during its formation.

To comply with such regulations, the riser pin traditionally is positioned within the same hemisphere as the true center of gravity and the marked heavy spot of the ball. In addition, the preferred area for drilling one or more gripping or finger holes of the ball generally is located in close proximity to the riser pin, with the riser pin often being used as a reference point for drilling the gripping holes. But, because the riser pin forms a break or open area in the cover stocks, it creates a weakened spot or area in one or more layers of the ball, the cover layer or cover stock of the ball can fail or crack during drilling and/or over time with use if the drilled gripping holes are formed too close to the riser pin.

Bowling ball manufacturers therefore generally set warranty limits regarding the proximity of the riser pin to the gripping holes, and drilling one or more gripping holes closer to the riser pin than permitted by such limits can void the ball's warranty. Unfortunately, the optimal placement area and patterning for the drilled gripping holes, e.g., the location of the gripping holes selected for maximizing the performance and tracking characteristics of the bowling ball by a bowler, may conflict with such warranty restrictions.

Accordingly, Applicants recognize that a need exists to provide expansion of the available area for drilling gripping holes in bowling balls, to achieve a variety of desired performance/reaction characteristics of balls, while still complying with governing regulations as to where such gripping holes can be drilled. The present disclosure addresses the foregoing and other related and unrelated issues/problems in the art.

### SUMMARY

Briefly described, the present disclosure is directed to bowling balls and methods of forming bowling balls. Such bowling balls can include a spherical body typically comprised of a plurality of layers or assemblies. The plurality of layers generally includes an inner core layer or assembly and, optionally, one or more outer core layers or assemblies, with a cover or cover stock layer applied thereover.

The inner core layer generally includes one or more elements or sections selected, constructed, and/or otherwise configured to provide the bowling ball with selected or desired performance characteristics and/or properties, for example, a selected weight, balance, etc. and/or various dynamic, reaction or other performance characteristics, which can differ by bowling preferences. The inner core layer generally is formed from a high-density liquid curable material, which can be cast as a single piece or in multiple pieces/sections. The inner core layer or assembly further can comprise a unitary structure or a plurality of sections/elements, including structures that are asymmetric with respect to one or more axes of the bowling ball, and also can comprise one or more sections/pieces that can be positioned/located substantially symmetric about one or more axes of the bowling ball. Various suitable inner core shapes, constructions or configurations, designed to provide a variety of bowler desired/selected characteristics, can be used without departing from the scope of the present disclosure.

The outer core layer (or layers) is formed about the inner core layer, at least partially surrounding and supporting the inner core layer. The outer core layer can be formed from a curable material poured or injected into a mold and generally will have a substantially spherical outer surface, though the outer core layer can have any other suitable shape/construction without departing from the scope of the present disclosure. The inner core layer further will be at least partially supported within the outer core layer mold by one or more support posts/rods during casting of the outer core material thereabout, to support the inner core layer at a desired position or orientation within the outer core layer to provide desired performance and/or tracking characteristics of the finished ball, e.g., the static balance and other dynamic or reactive performance properties thereof.

The cover stock layer generally is formed about the outer core layer, surrounding and encapsulating the inner and outer core layers of the ball. The cover stock layer typically forms the outer surface of the ball, and finishing and/or substantially sealing the outer and inner core layers, and providing the ball with a substantially smooth, spherical outer surface. The cover stock layer also can be formed from a liquid curable material poured or injected into a mold, in which the previously formed inner core layer and outer core layer generally are supported by a support rod or post.

The bowling ball further will include a riser pin or other similar support feature that generally comprises a filler material (e.g., a liquid curable material) received within a hole or passage formed by the one or more support posts or rods used during the formation/casting of the different layers of the ball. The riser pin feature generally will extend through the cover stock layer, at least partially through the outer core layer, and may extend at least partially into the inner core layer.

In one embodiment, the riser pin feature will be located in the opposite hemisphere of the bowling ball from the hemisphere in which the true center of gravity and the marked heavy spot of the bowling ball are located. In one aspect, the positioning of the riser pin feature will be located by supporting the plurality of elements/layers, e.g., inner core, the outer core, and the cover stock layers, inside their mold(s) at an offset position, that generally will be approximately 180° from the typical riser pin support location of the ball based on the true center of gravity and/or projected heavy spot of the bowling ball, and will thus be at a location in compliance with USBC regulations requiring that one end of the low RG axis of the ball be within about a 1″ radius of the center of the riser pin.

In a further embodiment, the bowling ball can be constructed with at least one core support feature supporting the inner and the at least one outer core layer during formation thereof in a top hemisphere portion of the bowling ball. The core support feature can define a hole or passage formed at least partially through one or more of the core layers/elements of the bowling ball, in which a filler material is received so as to substantially fill this hole/passage. In addition, after the outer core assembly is formed, a further or second support hole or passage will be at least partially drilled or bored through one or more layers of the bowling ball, e.g., the outer core and possibly into the inner core assemblies, at an offset position about 180° opposite the core support feature. This second drilled support hole will receive a secondary support post/rod used to support the core assembly, e.g., the outer and inner core layers, in a mold during formation/casting of the cover stock layer thereabout. A further hole/passage thus is formed in the cover stock layer, substantially coaxial with the second drilled support hole, and which generally will be at least partially filled with a filler material to form the riser pin feature of the ball. As a result, the riser pin will be located in the opposite hemisphere from the true center of gravity, marked heavy spot, gripping hole drilling area of the ball, and the additional support feature.

The bowling ball further can include one or more marking features along the outer surface of the cover/cover stock layer, located along a dynamic axis of the bowling ball indicative of the traditional location of the riser pin as used to determine placement of the gripping/finger holes for achieving the desired performance or reactive characteristics or properties, e.g., rotation or other tracking characteristics, of the ball. In one embodiment, the marking feature(s) can include an engraving or marking on the outer surface of the cover stock of the ball, at a position that is directly opposite the riser pin feature along the outer surface of the cover stock. The marking or engraving can be used for determining where to drill the gripping/finger holes, in the manner that the traditionally received riser pin is used; however, there will be substantially no restriction as to how close the engraved mark can be relative to any of the drilled holes because the weakened area of the ball created by the riser pin will no longer be in or substantially close to the drilling area.

In yet another aspect, the present disclosure is directed to a method of forming a bowling ball. The method can include forming one or more inner core layers/assemblies of the bowling ball, for example, by cast molding a liquid curable material in one or more open pour mold or molds.

The method further can include forming an outer core layer about the inner core layer(s) upon casting/setting thereof. The other core layer can be formed by casting the outer core layer which can include a liquid curable material, in an open pour mold. During casting of the outer layer, the method can include at least partially supporting the inner core layer within the outer core layer using a support rod or post. For example, the inner core layer can be supported within the mold for forming the outer core layer at a position that achieves specific properties or characteristics for the final formed bowling ball. In one example, the inner core layer/assembly can be engaged or otherwise supported by the support post/rod at a location that is offset approximately 180° from where the inner core is traditionally supported in conventional casting methods.

Upon setting/formation and demolding of the inner/outer core layers, the method may include forming a cover stock layer about the inner/outer core layers. The cover stock layer can be formed in an open pour mold with the inner core and outer core layers supported therein by a support pin or rod. The support rod can be aligned with and at least partially received within the hole/passage formed in the outer core (or inner core) assemblies/layers, and upon formation/setting of the cover stock material, the support post/rod can form/define a hole or passage in the cover stock layer, which hole or passage can be substantially coaxial with the hole/passage in the outer core layer.

Thereafter, a filler material will be introduced into the holes/passages defined during formation of the outer core and cover stock layers, forming a riser pin feature, which will be located in the opposite hemisphere from the true center of gravity and the marked heavy spot of the final ball.

In another embodiment, a method for forming a bowling ball may include forming one or more elements/sections of an inner core layer, for example, by cast molding one or more liquid curable materials in one or more open pour molds.

Upon formation of the inner core layer, an outer core layer will be formed thereabout, for example, by cast molding a liquid curable material in an open pour mold, with the inner core layer at least partially supported within the mold for the outer core layer with one or more support rods or posts. The support rods/posts may form or otherwise define a hole or passage in the outer core layer upon setting thereof.

Upon formation of the outer core layer about the inner core layer, a filler material will be received within the hole/passage defined by the support rod/post used during formation of the outer core.

Thereafter, a secondary hole or passage will be formed (e.g., by drilling, boring, etc.) in the outer core layer. Such a secondary hole or passage generally will be formed on an opposite side of the outer core layer, i.e., approximately 180° offset, from the previously formed filled in hole. A second support rod/post can be inserted into the secondary drilled hole or passage for supporting the outer core assembly in the mold during formation of the cover stock layer thereabout. Upon formation/setting of the cover stock layer, a hole/passage will be defined therein by the secondary support post/rod. This hole/passage formed can be filled with a filler material (e.g., a liquid curable material) to at least partially define the riser pin feature of the ball. The riser pin feature will be in an opposite hemisphere as the support feature, as defined by an axis of the bowling ball that extends through the geometric center of the ball and extends in a direction that is substantially perpendicular to the riser pin and/or support feature.

As a result, bowling balls formed according to embodiments of the present disclosure may allow for the removal/relaxation of drilling restrictions while maintaining compliance with the USBC regulations by moving the riser pin support to the opposite side of the inner core, which causes the riser pin to be about 180° opposite from its current position. The location of the riser pin within the bottom hemisphere of the ball enables compliance with the USBC regulations requiring an end of the low RG axis to be a within 1″ of the riser pin, while also enabling greater flexibility in the drilling of gripping holes in terms of placement and patterning thereof to obtain a bowler's desired performance preferences. In this way, the durability of the drilled balls can be improved, a reduction in warranty costs can be achieved, and the drilling locations can be more flexible.

Those skilled in the art will appreciate the above stated advantages and other advantages and benefits of various additional embodiments by reading the following detailed description of the embodiments with reference to the below listed drawing figures.

### BRIEF DESCRIPTION OF THE FIGURES

The accompanying drawings, which are included to provide a further understanding of the embodiments of the present disclosure, are incorporated in and constitute a part of this specification, illustrate embodiments of the present disclosure, and together with the detailed description, serve to explain the principles of the embodiments discussed herein. No attempt is made to show structural details of this disclosure in more detail than may be necessary for a fundamental understanding of the exemplary embodiments discussed herein and the various ways in which they may be practiced. According to common practice, the various features of the drawings discussed below are not necessarily drawn to scale. Dimensions of various features and elements in the drawings may be expanded or reduced to more clearly illustrate the embodiments of the disclosure.

FIG. 1 shows a cross-sectional view of a bowling ball according to one aspect of the present disclosure.

FIG. 2 shows a cross-sectional view of a bowling ball according to another aspect of the present disclosure.

FIG. 3 shows a perspective view of a bowling ball according to principles of the present disclosure, with a marking feature or other indicia on the outer surface thereof.

FIG. 4 shows a schematic representation of a process/method for forming the ball according to FIG. 1.

FIG. 5 shows a schematic representation of a process/method for forming the ball according to FIG. 2.

Various objects, features and advantages of the present disclosure will become apparent to those skilled in the art upon a review of the following detail description, when taken in conjunction with the accompanying drawings.

### DETAILED DESCRIPTION

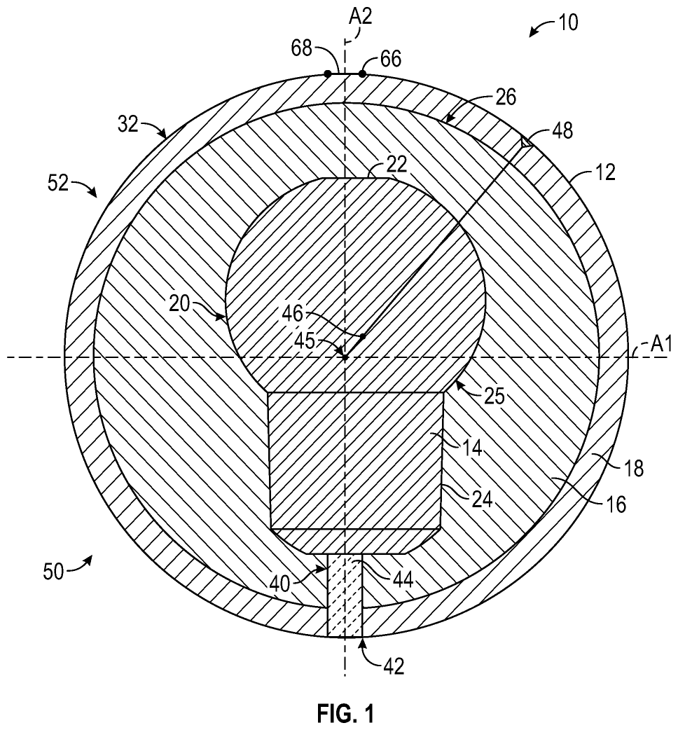

Referring now to the drawings wherein like reference numerals designate corresponding parts throughout the several views, FIGS. 1-5 illustrate components of bowling balls and methods for forming bowling balls according to principles of the present disclosure. The following description is provided as an enabling teaching of embodiments of this disclosure. Those skilled in the relevant art will recognize that many changes can be made to the embodiments described, while still obtaining the beneficial results. It will also be apparent that some of the desired benefits of the embodiments described can be obtained by selecting some of the features of the embodiments without utilizing other features. Accordingly, those who work in the art will recognize that many modifications and adaptations to the embodiments described are possible and may even be desirable in certain circumstances. Thus, the following description is provided as illustrative of the principles of the embodiments of the present disclosure and not in limitation thereof.

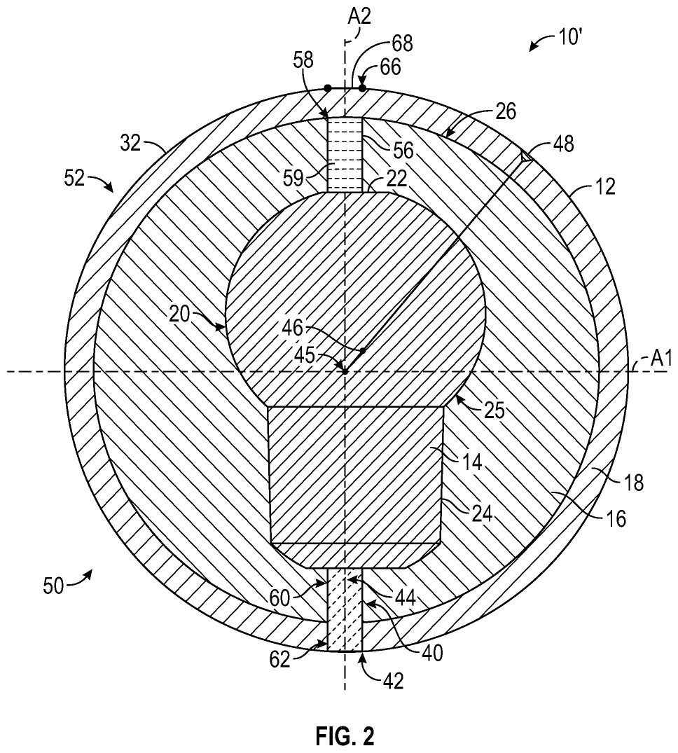

FIGS. 1-2 show examples of bowling balls 10/10′ constructed according to principles of the present disclosure. The bowling ball 10/10′ generally will be a performance bowling ball, which includes a spherical body 12 typically will have a lower moment of inertia or Radius of Gyration (RG) than a solid sphere of the same weight. The ball 10/10′ can be comprised of a plurality of layers or assemblies 14, 16, and 18. The plurality of layers generally includes an inner core layer or assembly 14, one or more optional outer core layers or assemblies 16, and a cover or cover stock layer or assembly 18 formed or applied over the inner or outer core assemblies 14/16.

As shown in FIGS. 1-2, the inner core layer/assembly 14 can include one or more elements or sections 20 that can be shaped, constructed, or otherwise configured to provide the bowling ball 10/10′ with selected/desired properties. For example, to create a dynamic imbalance within the ball to provide various selected or desired dynamic characteristics, such as selected differential radius of gyration (RG) of about 0.025 or greater (generally determined as the difference between the maximum RG and the minimum RG, and which can be varied by changes in the shape and weight of the inner and outer core), desired weight, static balances and/or other performance or reactive characteristics, e.g., spin, trajectory, etc. The inner core assembly 14 also can be provided with a shape having prescribed aspect ratio, e.g. the core can be taller than it is wide. The inner core layer 14 further generally can be formed from a high density material, such as urethane, polyester, epoxy, or other synthetics or polymeric materials with appropriate fillers to achieve the desired density of the inner core part. The inner core layer 14 can be set or cured in one or more open pour molds, machined from appropriate billets, or formed in any other suitable manner without departing from the scope of the present disclosure.

In some aspects, the inner core assembly 14 can comprise a plurality of sections/elements including a first section or element 22 having a generally spherical shape, and a second element or section 24 having a different shape or configuration, such as a generally cylindrical shape as shown in FIGS. 1-2, such that the inner core assembly 14 is substantially asymmetric about one or more axes of the bowling ball 10/10′, e.g., a horizontal axis A1 defined through the geometric center 45 of the bowling ball 10/10′. The sections 22, 24 of the inner core assembly can have any suitable shape, however, without departing from the present disclosure, e.g., spherical shapes, cylindrical shapes, circular shapes, conical shapes, cube or cuboid shapes, triangular shapes, polygonal shapes, e.g., convex and concave polygonal shapes, or regular and irregular polygonal shapes, or regular and irregular amorphous shapes and/or other suitable shapes or configurations or combinations thereof. In addition, though FIGS. 1-2 show the inner core assembly 14 to have more than one element/sections that can be formed sequentially to form a substantially unitary structure, the inner core assembly can include a single formed element, for example, having an asymmetric (e.g., a mushroom-like shape) or symmetric shape (e.g., a sphere, cylinder, etc.) or another suitable shape, construction, or configuration to provide desired/selected characteristics or properties, without departing from the present disclosure.

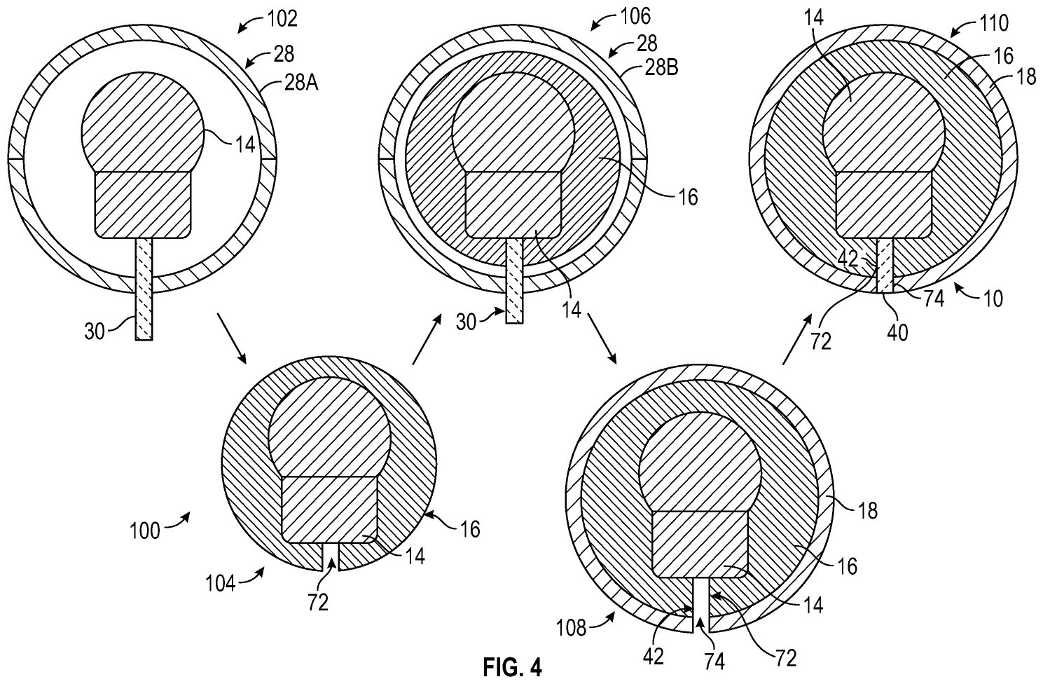

As further shown in FIGS. 1-5, the bowling ball 10/10′ can have an outer core layer/assembly 16 formed about the inner core layer 14 so as to at least partially surround and at least partially support the inner core layer 14. The outer core layer 16 can have a cavity or void 25 in which the inner core layer/assembly 14 is received/contained, and further can have substantially spherical outer surface or face 26. The outer core layer 16 can have any suitable shape/construction, e.g., elliptical, ovoid, rectangular, or other suitable geometry, however, without departing from the scope of the present disclosure. The outer core layer 16 generally will be formed from a liquid curable material, such as a urethane, polyester, epoxy, or other polymeric or synthetic materials with appropriate fillers to achieve the desired density of the outer core layer. As shown in FIG. 4, the outer core material can be introduced into a mold 28 and about the inner core layer 14, with the inner core layer 14 generally being at least partially supported within the mold 28 by one or more support posts/rods 30. The support post 30 will support the inner core layer 14 at a desired position or orientation within the outer core layer 16 during molding and setting/curing of the outer core layer 16 thereabout, which position or orientation can be selected or determined so as to impart desired control characteristics of the finished ball, e.g., the static or dynamic balance and other suitable performance or reaction properties thereof.

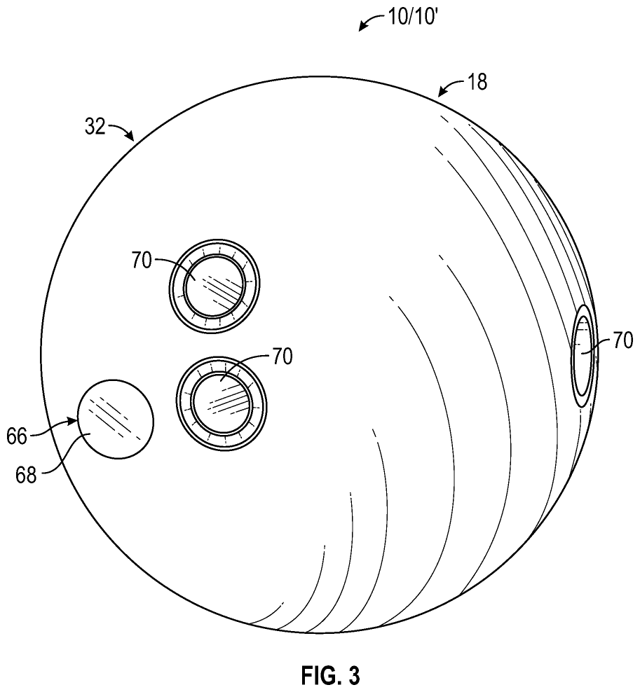

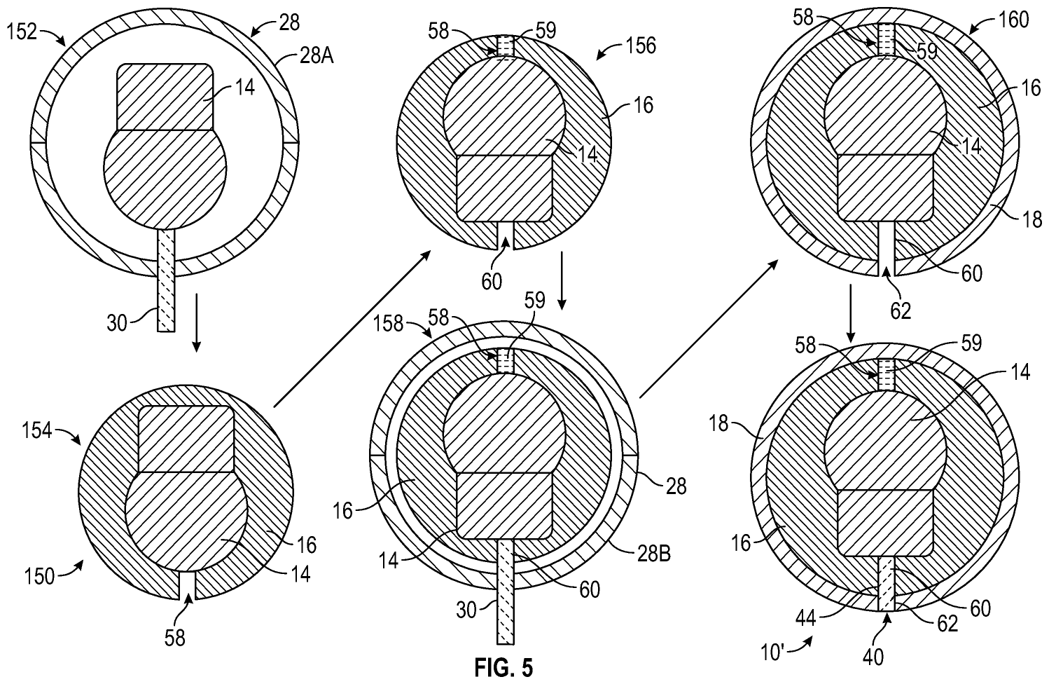

As additionally shown in FIGS. 1-2, the cover stock layer 18 is formed about the outer surface 26 of the outer core layer 16, generally surrounding and encapsulating the outer core layer 16 of the ball 10/10′. It will be understood, however, that the outer core layer/assembly 16 is an optional layer and the cover stock layer 18 can be formed directly about the inner core layer 14. The cover stock layer 18 typically will substantially seal the outer and inner core layers 14/16, and generally a substantially spherical outer surface 32 for the finished ball 10/10′, as shown in FIG. 3. The cover stock layer 18 can be formed from a liquid curable material that can include polyester, urethane, epoxy, or other polymeric materials, with suitable dyes and pigments which may be reactive (e.g., contain additives for interacting with the surface of a bowling lane to provide desired performance characteristics, e.g., spin, trajectory, etc.) or non-reactive. The cover stock material will be poured, injected or otherwise introduced into a mold 28 in which the inner core layer 14 and the outer core layer 16 generally are supported such as by one or more support posts or rods 30 during pouring, curing and setting/molding of the cover stock layer (FIGS. 4-5).

The bowling ball 10/10′ further will include a riser pin feature 40 generally formed/received within a hole or passage 42 formed by the support posts 30 used during the formation/casting plurality of layers of the ball. The riser pin feature 40 can include a filler material 44 at least partially received within the hole or passage 42. For example, as shown in FIGS. 1 and 2, the riser pin feature 40 will extend at least partially through the outer core layer 16 and through the cover stock layer 18. The filler material 44 for the riser pin feature further can include a liquid curable material, such as an epoxy or polyester, though any liquid curable material that is suitably durable or precast solid that is inserted in the hole or passage 42 can be used without departing from the scope of the present disclosure.

According to embodiments of the present disclosure, the riser pin feature 40 will be located in the opposite hemisphere of the bowling ball 10/10′ from the hemisphere containing the true center of gravity 46 and the marked heavy spot 48 of the bowling ball 10/10′. For example, the riser pin feature 40 can be in a bottom hemisphere 50, while the true center of gravity 46 and marked heavy spot 48 can be in a top hemisphere 52 (as defined by axis A1 in FIGS. 1-2). This positioning of the riser pin feature 40 will be accomplished by supporting the plurality of elements/layers, e.g., inner core 14, the outer core 16, and the cover stock 18 layers, at an offset position that will be reoriented approximately 180° with respect to the Low Radius of Gyration (RG) axis of the ball, substantially opposite from the positioning of the riser pin in traditional molding processes. For example, the Low RG axis A2 generally can extend through the geometric center 45 of the ball and at least partially define a dynamic axis of the ball whereby placement of the finger or gripping holes in different patterns and/or at different distances or positions with respect to this dynamic axis provides/enables the bowler to impart different reactionary or dynamic characteristics (e.g. spin, trajectory, etc.) to the ball. As a result of repositioning/locating the riser pin in the final ball 10/10′, the riser pin feature 40 is provided/located within about 1″ of an end of the low RG axis A2 as required by USBC regulations, but the weakened area/spot generally created by the riser pin is moved away from the area at which the gripping holes will be formed. As a further result, the locations and patterning configurations for the gripping holes will be expanded to enable greater variation to match bowler preferences, but with the potential for cracking the ball due to drilling too close to or into the riser pin being substantially eliminated.

In the embodiment illustrated in FIG. 2, the bowling ball 10′ can include at least one support feature 56 positioned substantially opposite the riser pin feature 40. This support feature 56 can include a hole or passage 58 formed at least partially through one or more of the layers/element of the bowling ball 10′, in which a filler material 59 is at least partially received. For example, the hole or passage 58 may be defined/formed at least partially through the outer core layer 16 and potentially into one or more elements/sections of the inner core layer of the bowling ball 10′, such as due to use of a support post or rod 30 to support the outer and/or inner core assembly 16 during formation/casting thereof. Upon setting of the outer core assembly 16, this hole/passage 58 will be filled with an epoxy, or polyester material, or other suitable liquid curable filler material.

Additionally, in the embodiment shown in FIG. 2, a second hole or passage 60 can be at least partially formed (drilled, bored, etc.) into/through one or more of the outer 16 and/or inner 14 core layers of the bowling ball 10′, at a position that is about 180° opposite the hole or passage 58 for the inner and outer core layers/assembly (FIG. 5, Step 156). A secondary support post/rod 30 can be placed into this hole 60 to support the outer core assembly 16 (and potentially the inner core assembly 14), in the mold 28 during formation/casting of the cover stock layer 18. The support rod or post 30 further can form/define a hole/passage 62 in the cover stock layer 18 that is substantially coaxial with the hole/passage 60 (which passages 60 and 62 may at least partially form passage 42). This passage 62 further can be filled in or otherwise at least partially receive filler material 44 to form the riser pin feature 40, which will be located in the opposite hemisphere from the true center of gravity 46 and marked heavy spot 48, as well as the first or initial support pin 56.

As further shown in FIGS. 1-3, the bowling ball 10/10′ can include one or more surface features 66 arranged along an outer surface 32 of the cover/cover stock 18. The one or more surface features 66 can include at least one marking feature 68 placed along in the ball cover stock 18 to indicate the traditional location of the riser pin for use in determining placement of the gripping/finger holes 70 (FIG. 3) along the top hemisphere 52 of the ball for achieving the desired characteristics or properties, e.g., spin, rotation, trajectory or other release characteristics of the ball 10/10′. In one embodiment, the marking feature(s) 68 can include an engraving or marking on the outer surface 32 of the cover stock 18 of the ball 10/10′, at a position that is directly opposite the riser pin feature 40. The marking or engraving 68 can be used for locating the drilled gripping holes 70, the manner as the traditionally received riser pin is used; however, there will be no restriction on how close the engraved mark can be relative to any of the drilled gripping holes 70 because the weakened area of the ball created by the riser pin no longer will be in the drilling area. The drilling options for placement and/or patterning of the gripping holes thus can be substantially increased so as to accommodate greater ranges of bowler specific performance characteristics, the durability of the ball can be improved, and the warranty restrictions can be relaxed for the end customer.

FIG. 4 shows a schematic illustration of a method/process 100 for forming the bowling ball 10 of FIG. 1. As shown in FIG. 4, the method 100 can include supporting one or more elements or sections of the inner core layer/assembly 14 of the bowling ball 10 that was previously constructed, for example with a liquid curing material received and set within one or more molds for formation of the different elements/sections thereof the inner core assembly 14, though the inner core layer can be formed in any suitable manner, e.g., machining, milling, etc., without departing from the scope of the present disclosure.

The method 100 further can include forming the outer core layer 16 about the inner core layer(s) 14 upon formation thereof. For example, at Step 102, the formed inner core layer 14 can be at least partially supported within a mold 28, e.g., an open pour mold 28A, for forming the outer layer 16 by a support rod or post 30. The inner core layer 14 can be supported at a position that achieves specific properties or characteristics (e.g., dynamic or performance characteristics) for the final bowling ball 10. The inner core layer/assembly 14 further can be engaged or otherwise supported by the support post/rod 30 at a location that is about 180° from where inner core layers/assemblies are supported in traditional casting/forming methods. With the inner core layer/assembly 14 at least partially supported in the mold 28A, the liquid curing material for forming the outer core layer 16 can be at least partially received within the mold 28A about the inner core layer/assembly 14. In one embodiment, the liquid curing material can be catalyzed to set within a selected time frame. Upon setting of the outer core layer 16, the formed outer core and inner core layers 14/16 can be demolded or removed from the mold 28A (Step 104). The support rod/post 30 further can be removed and generally will at least partially form or otherwise define a hole or passage 72.

As further shown in FIG. 4, after formation of the inner/outer core layers 14/16, the method 100 may include forming a cover stock layer 18 thereabout. For example, at Step 106, the formed inner/outer core layers 14/16 can be at least partially supported within a mold 28, e.g., an open pour mold 28B, for forming the cover stock layer 18, by a support rod 30. The support rod 30 can include the same or a different support rod used in casting of the outer core layer 16. The support rod 30 can be aligned with and be at least partially received within the hole/passage 72 defined/formed in the outer core layer 16. The liquid curable material for forming the cover stock layer 18 then can be received within the mold 28B, and can be allowed to set for a prescribed time period or otherwise cured for formation of the cover stock layer 18 about the inner/outer core layers 14/16. Upon formation/setting of the cover stock layer 18, the support post/rod 30 can be removed and generally will form/define a hole or passage 74 therein, which hole or passage 74 will be substantially coaxial with the hole/passage 72 in the outer core layer 16. Passages 72 and 74 may at least partially form hole/passage 42.

At Step 108, the formed cover stock 18, outer core 16, and inner core 14 layers can be removed or demolded from the mold 28B, and thereafter, the method 100 can include filling or otherwise receiving a filler material (e.g., including a liquid curable material) into the hole/passage 42 defined by the support rods 30 used during formation of the outer core 16 and cover stock 18 layers, thereby forming the riser pin feature 40 (Step 110), which will be located in the opposite hemisphere from the true center of gravity 46 and the marked heavy spot 48 of the final ball 10 (as shown in FIG. 1).

Further, one or more surface features 66, e.g., at least one marking feature 68, can be formed or otherwise defined into the outer surface 32 of the cover stock layer 18, e.g., by stamping, engraving, pressing, embossing, etc. or other suitable methods for marking a bowling ball without departing from the scope of the present disclosure.

FIG. 5 shows a method/process 150 for forming the bowling ball 10′ according to FIG. 2. The process/method 150 for forming the bowling ball 10′ may include supporting one or more elements/sections of the inner core layer 14 of the bowling ball 10′ that was previously constructed, for example, by cast molding a liquid curing material in one or more open pour molds.

Upon placement of the inner core layer 14, the method 150 can include forming the outer core layer 16 thereabout. At Step 152, the method 150 can include at least partially supporting the inner core layer 14 within a mold 28A for forming the outer core layer 16 with one or more support rods or posts 30. The liquid curable material for forming the outer core layer can then be received within the mold 28A and the outer core layer 16 can be allowed to set or cure. Upon setting of the outer core layer 16, the support rod/post 30 may define a hole or passage 58 at least partially through the outer core layer 16.

Further, upon formation/setting of the outer core layer 16, the inner/outer core layers 14/16 can be demolded or otherwise removed from the mold 28A (Step 154), and, at Step 156, the method 150 can include receiving a filler material 59 (e.g., a liquid curing material) in the hole/passage 58 defined by the support rod/post 30 used during formation of the outer core layer 16.

Further, at Step 156, the method 150 can include forming, e.g., drilling, boring, etc., a hole or passage 60 in the outer core layer 16. The hole or passage 60 may be formed on the opposite side of the outer core layer from the filled-in hole 58.

At Step 158, the method 150 additionally will include aligning and inserting or receiving a support rod/post 30 into the hole or passage 60 to support the outer core layer 16 in mold 28B for forming the cover stock layer 18. The formed inner and outer core assemblies 14/16 further can be rotated and positioned within the mold 28B for the cover stock layer 18. With the formed outer/inner core layers 14/16 at least partially supported within mold 28B, the liquid curing material for forming the cover stock layer 18 can be received within the mold 28B, and can be allowed to set or otherwise be cured. The support rod/post 30 received within the drilled hole/passage 60 may at least partially support the inner and outer core layers 14/16 at a desired position within the mold 28B. At Step 160, the formed cover stock 18, outer core 16, and inner core 14 layers/assemblies can be demolded or removed from the mold 28B. Upon formation/setting of the cover stock layer 18, a hole/passage 62 will be formed therein due to the presence of the support post/rod 30, which hole/passage 62 may be substantially coaxial with the drilled hole 60.

Thereafter, at Step 162, the hole/passage 62 formed by the support/post 30 and the drilled hole/passage 60 can be filled in with a filler material 44 to at least partially define the riser pin feature 40. The riser pin feature 40 will be in an opposite hemisphere (as defined by axis A1 in FIG. 2) as the support feature 56, the marked heavy spot 48, and the true center of gravity 46.

Additionally, one or more surface features 66, e.g., marking features, can be formed or otherwise defined into the outer surface 32 of the cover stock layer 18 of the ball 10′, e.g., by stamping, pressing, engraving, embossing etc.

The foregoing description generally illustrates and describes various embodiments of the present disclosure. It will, however, be understood by those skilled in the art that various changes and modifications can be made to the above-discussed construction of without departing from the spirit and scope thereof as disclosed herein, and that it is intended that all matter contained in the above description or shown in the accompanying drawings shall be interpreted as being illustrative, and not to be taken in a limiting sense. Furthermore, the scope of the present disclosure shall be construed to cover various modifications, combinations, additions, alterations, etc., above and to the above-described embodiments, which shall be considered to be within the scope of the present disclosure. Accordingly, various features and characteristics of the present disclosure as discussed herein may be selectively interchanged and applied to other illustrated and non-illustrated embodiments, and numerous variations, modifications, and additions further can be made thereto without departing from the spirit and scope of the present invention as set forth in the appended claims.

What is claimed is:

1. A bowling ball, comprising:
a plurality of core layers including an inner core layer, and an outer core layer at least partially received about the inner core layer, the inner core layer including a high density material and being shaped, constructed, and/or configured to provide the bowling ball with one or more prescribed properties or characteristics;
a cover stock layer including a liquid curable material received about the outer core layer;
a riser pin feature including a passage extending through at least the cover stock layer and/or the outer core layer and a filler material that is at least partially received within the passage, the riser pin feature being located in an opposite hemisphere of the bowling ball from a hemisphere including a true center of gravity and a marked heavy spot of the bowling ball and being arranged within about 1 inch of an end of a Low Radius of Gyration Axis of the bowling ball; and
at least one marking portion for locating one or more gripping holes along the cover stock layer, the at least one marking portion being arranged along the hemisphere including the true center of gravity and the marked heavy spot of the bowling ball and 180 degrees opposite from the riser pin feature.

2. The bowling ball of claim 1, wherein shapes and weights of the inner core layer, the outer core layer, and the cover stock layer create a differential radius of gyration of at least 0.025.

3. The bowling ball of claim 1, wherein the inner core layer comprises a plurality of elements arranged so as to be asymmetric about at least one axis of the inner core layer.

4. The bowling ball of claim 1, wherein the riser pin feature extends at least partially through the outer core layer.

5. The bowling ball of claim 4, wherein at least a portion of the passage of the riser pin feature is formed by a support rod for supporting the inner and outer core layers in a mold during formation of the cover stock layer about the outer core layer.

6. The bowling ball of claim 5, wherein at least a portion of the passage of the riser pin feature is formed from drilling.

7. The bowling ball of claim 1, wherein the bowling ball comprises a moment of inertia that is lower than a moment of inertia of a solid sphere of an equivalent weight.

8. A method for forming a bowling ball, comprising:
supporting at least one core layer within a mold with a support, the at least one core layer comprising a high density material having a configuration and being supported at a position to provide the bowling ball with selected performance properties and/or characteristics;
introducing a liquid curable material about the at least one core layer and forming a cover stock layer about the at least one core layer, wherein the support at least partially forms a passage in the cover stock layer; and
receiving a filler material in the passage in the cover stock layer to form a riser pin feature that is in an opposite hemisphere from a true center of gravity and/or a marked heavy spot of the bowling ball.

9. The method of claim 8, wherein the at least one core layer comprises an inner core layer, and the method further comprises:
at least partially supporting the inner core layer in at least one additional open pour mold for formation of an outer core layer with the support and/or an additional support;
providing a liquid curing material to the additional open pour mold about the inner core layer to form the outer core layer wherein the support or the additional support at least partially forms a passage in the outer core layer.

10. The method of claim 9, further comprising:
receiving a filler material in the passage of the outer core layer to at least partially define a support feature.

11. The method of claim 10, further comprising:
forming an additional passage in the outer core layer that is opposite the support feature about the outer core layer.

12. The method of claim 11, further comprising:
receiving the support in the additional passage in the outer core layer; and
supporting the outer core layer in the open pour mold for the cover stock layer to form the cover stock layer thereabout, wherein the passage formed in the cover stock layer by the support is substantially coaxial with the additional passage.

13. The method of claim 12, further comprising:
receiving the filler material in the additional passage to at least partially form the riser pin feature.

14. The method of claim 8, further comprising:
forming one or more marking features in an outer surface of the cover stock layer for locating one or more gripping holes that is 180 degrees opposite from the riser pin feature.

15. A bowling ball, comprising:
an inner core layer including a high density material and that is shaped, constructed, and/or configured to give the bowling ball with one or more prescribed properties or characteristics;
an outer core layer that is at least partially received about the inner core layer;
a cover stock layer including a liquid curable material and that is received about the outer core layer, the inner core layer, the outer core layer, and the cover stock layer in combination providing a differential radius of gyration of at least 0.025 for the bowling;
a riser pin portion including a filler material that is received within a passage extending through at least the outer core layer and the cover stock layer located in an opposite hemisphere of the bowling ball from a hemisphere including a true center of gravity and a marked heavy spot of the bowling ball, and arranged within about 1 inch of an end of a Low Radius of Gyration Axis of the bowling ball; and
at least one marking portion for locating one or more gripping holes along the cover stock layer, the at least one marking feature being arranged along the hemisphere including the true center of gravity and the marked heavy spot of the bowling ball and being 180 degrees opposite from the riser pin feature.
